(19) United States
(12) Patent Application Publication
(10) Pub. No.: US 2004/0191531 A1
(43) Pub. Date: Sep. 30, 2004

(54) Transparent glass or glass ceramic panel with a pleasing metallic appearance for products with heating zones

(76) Inventors: Sabine Melson, Mainz (DE); Stefan Hubert, Engelstadt (DE)

Correspondence Address: STRIKER, STRIKER & STENBY, 103 East Neck Road, Huntington, NY, 11743, US

(21) Appl. No.: 10/620,132

(22) Filed: Jul. 15, 2003

(30) Foreign Application Priority Data
Jul. 19, 2002 (DE) 102 32 814.5

(51) Int. Cl. B32B 15/00; B32B 17/06

(52) U.S. Cl. 428/432

(57) ABSTRACT

The pleasing metal appearance of glass/glass ceramic panels (1) is typically produced by a metal foil/plate (6) on the side of the plate facing away or remote from the observer. According to the state of the art these foils/plates are glued to the glass/glass ceramic panel by means of a transparent adhesive. Because of the different thermal expansion coefficients of the metal foil/plate (6) and the glass/glass ceramic panel (1) this leads to mechanical stress. According to the invention the mechanical stress can be avoided when the metal foil/plate (6) is attached to the glass/glass ceramic panel in a force-locking manner without adhesive. In a preferred embodiment this attachment is made by a clamping joint, e.g. provided by springs. Also it is beneficial to provide a gap between the joined partners, which is filled by a heat conducting compensating mass (8), e.g. silicone oil.

### BACKGROUND OF THE INVENTION

1. Field of the Invention

The present invention relates to a transparent glass/glass ceramic panel for products with heating zones, on which a metal foil or metal plate is provided on a side of the glass/glass ceramic panel facing away from an observer for producing a pleasing metallic appearance.

2. Description of the Related Art

Products with a heating zone, in which glass/glass ceramic panels are used, typically are cooking ranges with glass/glass ceramic cooking surfaces, which have radiatively heated cooking zones, and fireplace viewing windows. The glass/ glass ceramic panel for cooking surfaces are typically, as described in EP 0 220 333, colored for reducing transmission, so that the functional components of the cooking field under the glass/glass ceramic panel are practically not observable from above. These cooking surfaces are practically not transparent and appear black to an observer.

Cooking surfaces formed by the above-described glass/glass ceramic panels are generally provided with a decoration, which is provided for purely aesthetic reasons or for de-marking e.g. cooking zones in contrast to other regions of the cooking surface. These decorations and their application to the glass ceramic panel are, for example, described in DE 44 26 234 C1 (EP 0 693 464 B1) and DE 34 33 880 C2.

Because of the non-transparency of the colored glass or glass ceramic panel the decorations on the cooking surface are either typically printed by means of screen printing techniques or applied according to image-forming technology and subsequently burned in on the top side of the cooking surface. These state of the art techniques use ceramic paints having an enamel base. The decorations made in this manner include the so-called full-surface decorative cooking surfaces, in which the decoration almost completely covers the upper side of the cooking. surface, described, for example, in DE 197 28 881 C1 (DE29711 916.8U1).

With these known cooking fields with the topside decoration it is disadvantageous that they are provided on a non-transparent glass ceramic panel so that the ceramic decorative paints are applied only in a comparatively thin layer of only a few μm and thus do not have the desired brilliance. Furthermore the decoration form and thus the appearance of the cooking surface is not without restriction because of the difficulties depending on the printing technique, especially for the full-surface decorated cooking surface. Also only certain decorative paints can be used, which satisfy the specifications in practice, since the decorations applied to the top surface are exposed to a high mechanical and chemical attack, as described in DE 36 00 105 C2. These specifications include sliding or shift of pans, cleaning of overflowing and burned on cooking material, etc. Furthermore the decorations applied to the upper surface of the glass or glass ceramic panel stand in the way of providing a cooking surface that is as smooth as possible.

Glass/glass ceramic panels providing a cooking surface and made from a transparent, not colored glass ceramic material and printed on their underside with a heat resistant paint are described in JP 7-17409 and JP 51-89517. However these paint layers are applied to make the panels opaque. They replace the otherwise usual paint or ink, so that they appear black when observed. The decorations according to this reference are applied to the upper side of the panel and thus have the corresponding disadvantages, as described above.

DE 200 05 461 U1 also describes a cooking field with a transparent, not colored glass ceramic panel or a glass panel made from pre-stressed special glass as cooking surface, which has cooking zones heated with radiant heating elements. The cooking zones are provided with a decoration. An IR transmitting layer made from a heat-resistant pain is applied to its lower side. This IR transmitting layer applied to the underside forms a color-giving decorative coating and the upper side of the glass ceramic or glass panel is free of any decoration.

This reference also states that the underside decoration can be selected so that the metal decoration appears when the cooking surface is view from the top. This can be achieved by providing a heat resistant paint layer with metal effects or by flaming a thin aluminum foil on with highly transparent adhesives in cold regions of the cooking surface, i.e. outside of the cooking zones, if necessary in connection with a paint layer of heat-resistant paint. This latter paint layer especially can be a single layer or multi-layer noble metal and/or lustrous paint applied in the heated region.

In FIG. 5 this sort of structure is illustrated. This figure shows a cooking surface 1 on a glass/glass ceramic panel with a cooking zone 2, which is heated by a heated body 3. A metal foil or metal plate 6 is applied to the underside of the cooking surface outside of the cooking zone, i.e. in the cold region 4, by means of a coating 5 made of transparent adhesive. On the topside of the cooking surface an additional decoration 7 can be applied. The heated region, i.e. the cooking zone with a transition region, is typically provided with an unshown colored paint comprising a heat-resistant paint according to the state of the art.

Since the thermal expansion coefficients of the glass/glass ceramic cooking surface, on the one hand, and of the metallic foil/plate, on the other hand, are very different from each other, comparatively high stresses can result in operation. These comparatively high stresses can have a negative effect on the cooking surface when it is loaded and on the metal foils/plates. This is however not only true for the cooking surfaces, but also for other products with heated regions, such as fireplace windows.

### SUMMARY OF THE INVENTION

It is an object of the present invention to provide a transparent glass/glass ceramic panel of the above-described kind with a pleasing metallic appearance formed by a metal foil or plate applied to an underside of the glass/glass ceramic panel, so that no mechanical stresses are produced between both joined parts by thermal stresses and/or loads.

This object is attained in a transparent glass/glass ceramic panel for products with heated region, in which a metallic foil/plate is applied to the side facing away from an observing operator in order to produce a pleasing metal decoration.

According to the invention the metallic foil/plate is applied in a force-locking manner to the glass/glass ceramic panel without using an adhesive or glue.

Because of the adhesive-free application of the metal foil/plate mechanical stresses between the joined partners can be avoided, so that no negative action of the glass/glass ceramic panel and/or the metal foil/plate is produced.

There are several conceivable possibilities for force-locking adhesive-free application of the metal foil/plate. One simple method is provided when the means for application is a clamping joint. In the simplest case this clamping joint can be formed by springs.

It is also conceivable to provide magnetic means for retaining the metal foil/plate.

When the metal foil/plate is profiled or structured a special designer effect can be attained.

In order to avoid distortion or warping of the metal foil/plate the arrangement is set forth so that a definite air gap remains between the metal foil/plate and the glass/glass ceramic panel. Because of that the effects of the different thermal expansion coefficients of the glass/glass ceramic panel and the metal foil/plate can be avoided.

Preferably the air gap is filled with a thermally conducting compensating medium, e.g. silicone oils, the adhesion of the metal foil/plate is strengthened and compensation means for the different thermal expansion coefficients is provided.

So that the pleasing metal decoration is not weakened in spite of the compensation means, the arrangement is set forth so that the index of refraction of the compensation medium is adjusted to that of the glass/glass ceramic panel.

When the inventive features are provided in cooking surfaces with radiantly heated cooking zones the arrangement is set forth so that the metal foil/plate is applied outside the cooking zone and the cooking zones have an underside coating made from a heat-resistant pleasing metallic paint.

Because of that the entire cooking surface including the cooking zones can have a pleasing metallic appearance.

When the invention is applied to cooking surfaces with an inset atmospheric gas burner, the cooking surface is formed so that the metallic foil/plate is guided to the inset for the burner. This is possible because the temperature in the edge region of the inset is substantially less than in the cooking zone of the radiantly heated cooking surface.

### BRIEF DESCRIPTION OF THE SEVERAL VIEWS OF THE DRAWING

The objects, features and advantages of the invention will now be illustrated in more detail with the aid of the following description of the preferred embodiments, with reference to the accompanying figures in which:

FIG. 1 is a longitudinal cross-sectional view through a first embodiment of a radiantly heated glass/glass ceramic cooking panel according to the invention, with a metal foil applied to the cold region without adhesive for producing a pleasing metallic appearance on the cooking surface;

FIG. 2 is a longitudinal cross-sectional view through another embodiment of a glass/glass ceramic panel according to the invention with an additional heat conducting compensating layer between metal foil and the glass/glass ceramic panel;

FIG. 3 is a longitudinal cross-sectional view of an additional embodiment based on the embodiment shown in FIG. 1 with magnetic retaining means for the metal foil/plate;

FIG. 4 is longitudinal cross-sectional view through a glass/glass ceramic cooking panel with an atmospheric gas burner and metal foil/plate cladding in the form of a frame on the underside of the panel without adhesive or glue; and

FIG. 5 is a longitudinal cross-sectional view through a radiantly heated cooking panel with a pleasing metallic appearance according to the prior art.

### DESCRIPTION OF THE PREFERRED EMBODIMENTS

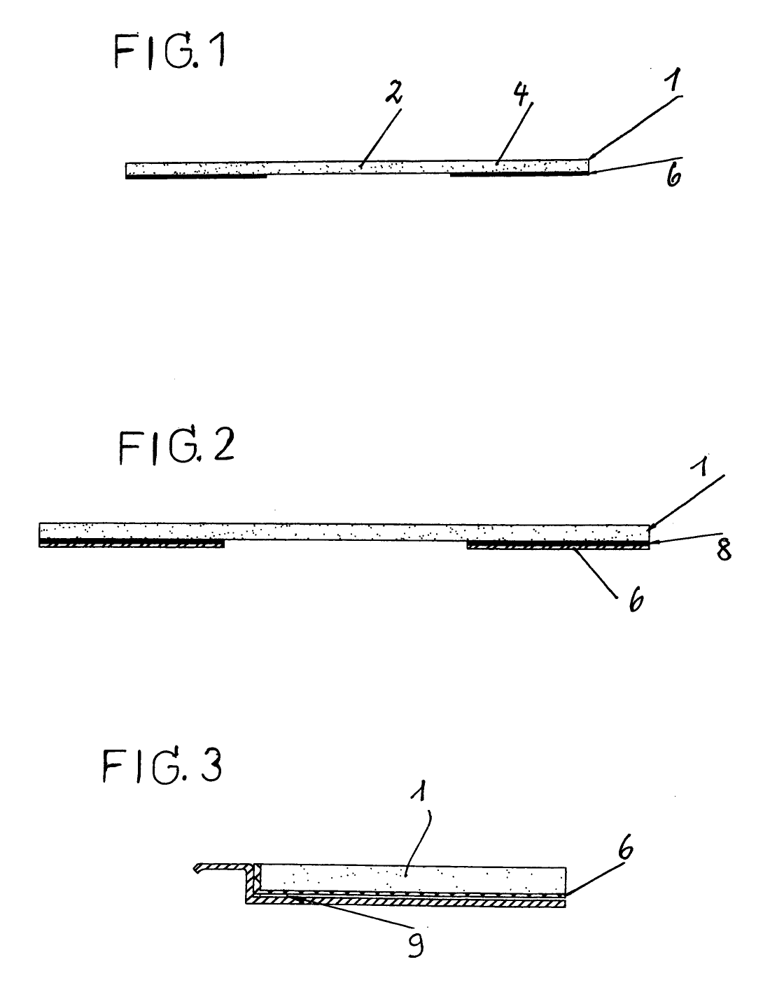

FIG. 1 is a schematic longitudinal view of a glass/glass ceramic panel 1 with a cooking surface having radiantly heated cooking zone 2. Outside of the cooking zone 2, i.e. in the so-called cold region 4, a metallic foil/plate 6 is arranged loosely on the underside of the glass/glass ceramic panel 1. Conventional form-locking but adhesive-free mechanical means are provided for that so that the foil/plate cannot become detached by itself. For example in the simplest case the foil/plate 6 can be pressed against the glass/glass ceramic panel 1 by means of a clamping joint, for example by springs, among other elements.

The metal foil/plate 6 can be profiled and/or structured as a design variant of the embodiment shown in FIG. 1. Similarly its surface can be mat or lustrous.

In the case of the basic embodiment shown in FIG. 1 the metal foil/plate 6 is in direct planar contact with the underside of the glass/glass ceramic panel 1.

Since, as already mentioned, the thermal expansion coefficient of the glass/glass ceramic cooking surface 1 and the metal foil/plate 6 can be very different, in spite of the adhesive-free application distortion or warping of the metal foil/plate can occur. This can be avoided, according to the embodiment shown in FIG. 2, since the metallic foil and/or plate 6 can be applied by means of the clamping joint under the glass/ glass ceramic panel 1 to form a definite air gap. This air gap can overcome the differences in the thermal expansion coefficients. It can be filled with a different media, in order to compensate for possible distortion or warping.

The air gap has a width between 0.01 and 5 mm and preferably can be filled with different thermally conductive compensating materials 8, which are fit to the index of refraction of the glass/glass ceramic panel so that they appear invisible.

For example if the glass ceramic panel 1 has an index of refraction of 2.54, silicon oil with an index of refraction of about 2.5 can be used as the compensating material 8.

This has the advantage that inevitable distortion and warping of the metal foil/plate 6, which can occur by thermal expansion, can be compensated.

In FIG. 3 an embodiment is shown, in which the metal foil/plate 6 is retained by magnetic force on the under side of the glass/glass ceramic panel without adhesive, since for example the embracing frame 9 of the cooking panel is magnetized.

In the illustrated embodiment the heated region is not provided with a coating. It can be provided with an underside printing, which reduces the transmission in the visible spectral range; the transmission in the visible spectral range may amount to 50% at maximum. Commercial glass ceramic paints can be used for printing on the underside, which currently are used for decorative purposes on the upper side of a non-transparent cooking surface. The paints are selected so that the strength of the cooking surface is guaranteed.

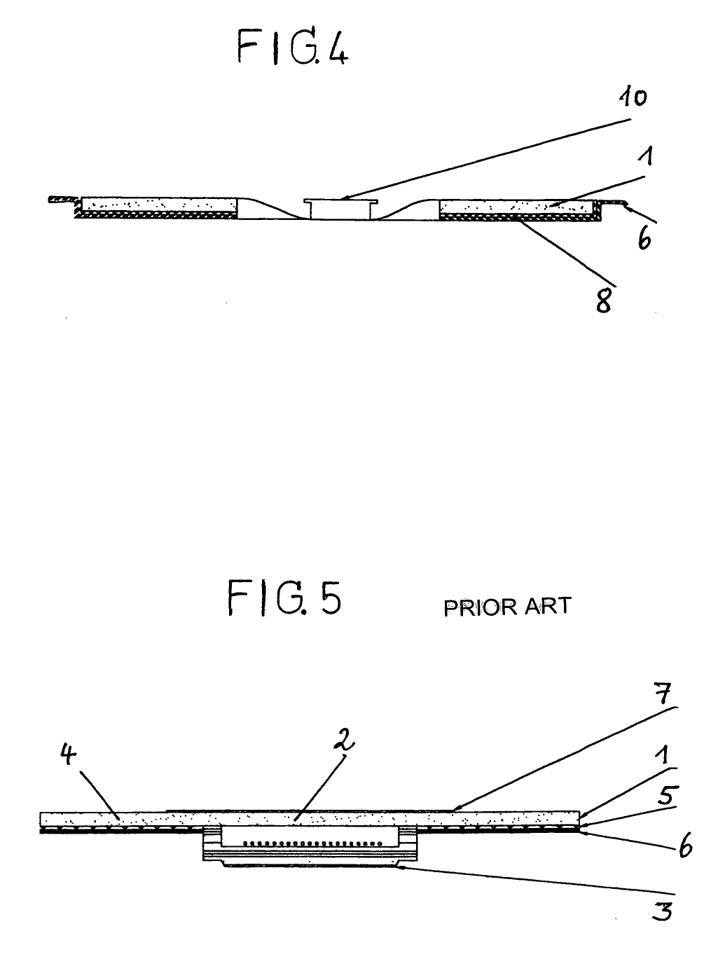

In FIG. 4 one embodiment of the cooking field with an atmospheric gas burner 10 is shown. The metal foil/plate 6 acting to provide the pleasing metallic appearance of the cooking field is a cladding in the form of a frame. A compensating layer 8 is provided between the foil/plate 6 and the underside of the glass/glass ceramic panel 1 similar to the embodiment shown in FIG. 2. As shown in FIG. 4, the metal foil/plate 6 can extend to the insets of the burners in cooking surfaces with atmospheric gas burners in the heated region.

The disclosure in German Patent Application 102 32 814.5-16 of Jul. 19, 2002 is incorporated here by reference. This German Patent Application describes the invention described hereinabove and claimed in the claims appended hereinbelow and provides the basis for a claim of priority for the instant invention under 35 U.S.C. 119.

While the invention has been illustrated and described as embodied in a transparent glass/glass ceramic panel with a pleasing metallic appearance for products with heated regions, it is not intended to be limited to the details shown, since various modifications and changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

We claim:

1. A transparent glass/glass ceramic panel for products with a heated region, said transparent glass/glass ceramic panel having a metal foil or metal plate applied to a side of said panel facing away from an observer in operation to provide a pleasing metallic appearance, wherein the metal foil or metal plate is attached to said side of said glass/glass ceramic panel in a force-locking manner without an adhesive.

2. The transparent glass/glass ceramic panel as defined in claim 1, further comprising means for providing a clamping joint between the metal foil or metal plate and the glass/glass ceramic panel.

3. The transparent glass/glass ceramic panel as defined in claim 2, wherein said means for providing a clamping joint comprises springs.

4. The transparent glass/glass ceramic panel as defined in claim 1, further comprising magnetic means for holding said metal foil or plate on said glass/glass ceramic panel.

5. The transparent glass/glass ceramic panel as defined in claim 1, wherein said metal foil or plate is profiled or structured.

6. The transparent glass/glass ceramic panel as defined in claim 1, wherein a definite air gap is provided between said side of said glass/glass ceramic panel and said metal foil or plate.

7. The transparent glass/glass ceramic panel as defined in claim 6, further comprising a heat conducting compensating medium filling said air gap.

8. The transparent glass/glass ceramic panel as defined in claim 7, wherein said heat conducting compensating medium (8) has an index of refraction about equal to that of said glass/glass ceramic panel (1).

9. The transparent glass/glass ceramic panel as defined in claim 7, wherein said heat conducting compensating medium is silicone oil.

10. The transparent glass/glass ceramic panel as defined in claim 1, further comprising a cooking surface including radiantly heated cooking zones and a pleasing heat-resistant metallic paint coating on an underside of the glass/glass ceramic panel in the cooking zones, and wherein said metal foil or said metal plate is provided on said panel outside of the cooking zones.

11. The transparent glass/glass ceramic panel as defined in claim 1, wherein said cooking surface is provided with insets for atmospheric gas burners and the metal foil or metal plate extends to the insets for the gas burners.
